(19) United States
(12) Patent Application Publication
(10) Pub. No.: US 2025/0325435 A1
(43) Pub. Date: Oct. 23, 2025

(54) DEVICES FOR ADDRESSING SOFT TISSUE PATHOLOGIES

(71) Applicant: Caroline Joy Yumul Co, Princeton, NC (US)

(72) Inventor: Caroline Joy Yumul Co, Princeton, NC (US)

(21) Appl. No.: 18/638,937

(22) Filed: Apr. 18, 2024

(51) Int. Cl. A61H 7/00

(52) U.S. Cl. CPC A61H 7/001; A61H 2201/0153; A61H 2201/1253; A61H 2201/168; A61H 2201/169; A61H 2201/1695

(57) ABSTRACT

A set of ergonomic soft tissue manipulation tools includes tools having an elongated monolithic body, with a first tapered end shaped in an arc corresponding to a contour of a selected part of the patient's body, with ridges formed on the body. The first tapered end is used to apply pressure to the skin of a patient's body to diagnose and treat soft tissue abnormalities. The versatile, ergonomic, and durable devices are designed and shaped to provide concentrated pressure. The ridges improve stability and leverage when treating soft tissue pathologies.

### CROSS-REFERENCE TO RELATED APPLICATION

This application is a continuation-in-part of U.S. design application Ser. No. 29/933,288, filed Mar. 19, 2024, the contents of which are herein incorporated by reference.

### BACKGROUND OF THE INVENTION

The present invention relates to therapeutic devices and, more particularly, to ergonomic devices for the treatment of soft tissue pathologies.

Inflammation of soft tissue areas of the human body may occur as the result of a major trauma, such as surgery, or a repeated micro-trauma, such as overtraining. The body responds by forming fibrous adhesions, or scar tissue, which is an unavoidable by-product of the healing process. The scar tissue forms in soft tissue areas of the human body, such as muscles, tendons, and ligaments. As scar tissue builds up, it prevents the muscles, tendons, and ligaments from lengthening and contracting, thereby resulting in lost range of motion, pain, and decreased stability. In addition, the build-up of scar tissue generally causes pain in the affected joint and surrounding areas. This pain often causes the sufferer to believe that an injury still exists; however, in most cases, the injury itself has healed. Therefore, it is desirable to remove the scar tissue so that the joint may achieve a greater level of performance.

Scar tissue is removed by a process known as soft tissue therapy, which involves use of the trainer's hand to manually massage the skin over the affected soft tissue areas to release scar tissue adhesions and regain lost resting length in the tissue. This type of massage includes cross-frictional massage, deep muscle massage, and rolfing.

Soft tissue therapy is useful in relieving musculoskeletal pathologies caused by thickened connective tissue, tight connective tissue, or trigger points. Current tools for assisting in soft tissue manipulation can cause discomfort to the therapist and patient alike because of their design and material makeup. Current tools for assisting in soft tissue therapy include the Graston Technique® and Astym® therapy. These tools typically lack ergonomical features thereby incurring excessive force, strain, and fatigue for a therapist. Furthermore, these tools are typically made from steel or plastic, which can cause discomfort when applied to a patient's skin, and/or lack durability. Graston tools are expensive, non-ergonomic, and made of steel, which can cause discomfort when applied to a patient's skin. Astym® therapy includes a small number of tools that are ergonomic but made from hard plastic that breaks easily.

Tools and methods for soft tissue massage therapy are shown in U.S. Pat. Nos. 5,231,977, 5,366,437, 5,441,478, 5,707,346 and 6,126,620 to D. A. Graston. These tools are used by a therapist or trainer to apply pressure to the skin of a patient for removal of fibrous scar tissue adhesions underlying the skin. “Patient” may refer to both humans and animals who may be under clinical care and/or research subjects enrolled in a research protocol.

Massage-based therapies, such as soft tissue mobilization or manipulation (“STM”), may also be used for improving soft tissue quality in patients with acute injuries, chronic injuries, and/or diseases (e.g., knee pain, plantar fasciitis, carpal tunnel syndrome). For example, massage-based therapies may improve the structure, function, and/or the blood flow of the cells at a specific portion of soft tissue.

One such massage-based therapy is instrument-assisted soft tissue mobilization (“IASTM”), in which a physical therapist, occupational therapist, chiropractor, doctor, athletic trainer, and/or any other professional trained in massage applies pressure to the soft tissue (e.g., muscle, tendon, ligament, and/or fascia) of a patient with a rigid device. Cells within the soft tissue are load sensitive and massage-based therapies, such as Quantifiable Soft Tissue Manipulation (QSTM™) and IASTM, are forms of mechanotherapy which provide direct mechanical stimuli to the cells to promote endogenous tissue healing, repair, and regeneration.

As can be seen, there is a need for devices for soft tissue manipulation that have improved and diverse functionality, improved ergonomics, and improved durability.

### SUMMARY OF THE INVENTION

In one aspect of the present invention, a set of ergonomic soft tissue manipulation tools is provided for applying pressure to the skin of a patient's body. Each of the ergonomic soft tissue manipulation tools includes an elongated monolithic body, having a first tapered end configured in an arc corresponding to a contour of a selected part of the patient's body, with a plurality of ridges formed on the elongated monolithic body. The first tapered end is operative to diagnose and treat soft tissue abnormalities.

In another aspect of the present invention, a first soft tissue manipulation device is provided. The first device can have a substantially cylindrical body, which can be continuously formed to a first substantially cone-shaped portion monolithically formed to a first base of the body and a second substantially cone-shaped portion monolithically formed to a second base the body. The first substantially cone-shaped portion can include at least a first teardrop shaped cutout portion having a plurality of ridges and a second teardrop shaped cutout portion having a plurality of ridges. The second substantially cone-shaped portion can include at least a first cutout portion having a plurality of ridges and a second cutout portion having a plurality of ridges.

In a further aspect of the present invention, a second soft tissue manipulation device is provided. The second device can have a substantially oval-shaped or biconvex base continuously formed to a substantially fin-shaped body having a first surface and a second surface. The first and second surface of the fin-shaped body can be formably attached to each other to form an edge portion along a perimeter of the second device. Furthermore, each of the first surface and the second surface can include a plurality of ridges disposed proximate to the substantially oval-shaped base.

In another aspect of the present invention, a third soft tissue manipulation device is provided. The third device can have a substantially cylindrically shaped body, which can include a base portion and a tip portion. The base portion of the third device can be substantially u-shaped and can be continuously formed to the body. The tip portion can be substantially shaped as a paraboloid bisected from an apex to a base and can continuously formed to the body. The third device can include a plurality of ridges disposed on the body and the tip potion of the device.

In another aspect of the present invention, a fourth soft tissue manipulation device is provided. The fourth device can include a claw-shaped body that defines a plurality of surfaces. The fourth device can have a plurality of ridges disposed on one of the plurality of surfaces.

In another aspect of the present invention, a fifth soft tissue manipulation device is provided. The fifth device can include a substantially crescent-shaped body that has a first and a second tip. Each of the first tip and the second tip have a semi-cylindrical cutout thereon which can cause each of the tips to form at least two prongs. Finally, the fifth device can include a plurality of ridges disposed about different aspects of the device.

In another aspect of the present invention, the plurality of devices is provided to a user as a kit for the treatment of soft tissue pathologies.

These and other features, aspects and advantages of the present invention will become better understood with reference to the following drawings, description, and claims.

### BRIEF DESCRIPTION OF THE DRAWINGS

FIG. 1 is a perspective view of a tool set, according to an embodiment of the present invention;

FIG. 2 is a top plan view thereof;

FIG. 3 is a perspective view of a first tool thereof;

FIG. 4 is a perspective view of a second tool thereof;

FIG. 5 is a perspective view of a third tool thereof;

FIG. 6 is a perspective view of a fourth tool thereof; and

FIG. 7 is a perspective view of a fifth tool thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a set of devices for soft tissue manipulation that are ergonomically formed from a durable and non-porous material to reduce therapist fatigue and improve patient comfort.

The instruments disclosed herein are generally referred to as a “wedge” tool, a “spoon” tool, a “fin” tool, a “cylinder” tool, and an “arc” tool. The “wedge” is used for precise targeting of origin and insertion points of muscles. The “spoon” is used for precise scraping of the body, similar to Gua Sha. The “fin” is used for muscle stripping for long muscles of the body. The “cylinder” has two ends, one having a rounded point and the other forming a blunt blade. One end is used for applying pressure to trigger points and the other end is used to apply pressure to surgical scars. The “arc” is used for fingers and toes.

The described instruments, through their distinctive design incorporating both curved and straight edges, are configured to match contours of soft tissues in the human body. They are specifically utilized for applying concentrated pressure and facilitating soft tissue mobilization treatments for diagnosing and treating soft tissue abnormalities. These tools are versatile, suitable for treating extensive muscle areas as well as more delicate regions. Their ergonomic design ensures ease of use and precise pressure application, thus improving both diagnostic and therapeutic efficiency.

The devices of the present subject matter may have grip-enhancing texturing thereon to improve soft tissue manipulation such as a ridge or recess/groove. The texturing may improve gripping, prevent slippage, and improve leverage. For ease of description, the Figures below illustrate ridges. However, the texturing may be present as grooves in some embodiments.

Any suitable non-porous material of sufficient hardness to promote durability may be used. Preferably, the material is durable, resonant, and biocompatible. For example, a thermoset photopolymer resin may be used.

In our pursuit to advance therapeutic tools within the domain of soft tissue mobilization, we have developed the “Ergonomic Instrument Soft Tissue Mobilization Tools,” utilizing cutting-edge Stereolithography (SLA) resin technology. We have discovered that this choice of material significantly distinguishes our instruments from those traditionally crafted from Acrylonitrile Butadiene Styrene (ABS) plastic, such as the Astym® instruments. ABS is a thermoplastic polymer commonly used with filament 3D printing. The inherent properties of SLA resin, combined with the precision of the Stereolithography process, allow our tools to achieve a layer resolution of 50 microns (0.05 mm), in stark contrast to the 250 microns (0.25 mm) layer thickness associated with ABS plastic tools made through Fused Deposition Modeling (FDM). This fivefold increase in resolution facilitates an unparalleled level of detail and smoothness on the surface of our tools, enhancing both their effectiveness in therapeutic applications and comfort in use. These enhancements, borne from the superior capabilities of SLA resin over ABS plastic, not only set our tools apart on a material level but also offer tangible benefits to practitioners and patients alike, showcasing a significant leap in the evolution of soft tissue mobilization instruments.

Conventional instruments made from ABS plastic, such as those by Astym®, Graston, and other Instrument Assisted Soft Tissue Mobilization (IASTM) methodologies, have predominantly focused on treating areas such as the arms, legs, neck, and back. The exceptional precision afforded by SLA resin technology enables our tools to be used effectively on the face, a delicate area that requires utmost accuracy and gentleness, thus broadening the scope of treatable areas beyond what has been traditionally addressed by existing tools. This precision mirrors the requirements of Gua Sha, a revered method in traditional Chinese medicine that seeks to promote the flow of qi (energy) by scraping the skin with a blunted tool to alleviate pain, tension, and stagnation. Gua Sha, aimed at moving blocked energy, blood stasis, or stagnation to relieve aches and improve joint movement, benefits immensely from the high-resolution detail and smoothness of our tools. These characteristics make our instruments well suited for the gentle yet effective application of Gua Sha techniques, not only on currently commonly applied areas but also on the face, offering a modern adaptation to a time-honored practice.

Furthermore, our innovative design includes unique features such as a 25% larger size as compared to Astym® tools for broader coverage, strategically placed broken ridges for improved grip, and deeper grooves for optimized functionality. This design is informed by the superior capabilities of SLA resin, showcasing a leap in innovation for soft tissue mobilization that bridges ancient healing practices with modern technology.

The distinct composition and design of our “Ergonomic Instrument Soft Tissue Mobilization Tools,” particularly leveraging Stereolithography (SLA) resin, not only meet but exceed the therapeutic capabilities of traditional instruments made from ABS plastic or metal. Without being bound by theory, our tools are believed to have an inherent ability to resonate in harmony with the natural frequencies of the human body, i.e., to conduct and amplify sound waves and vibrations as the tool glides over soft tissues. The density of the photopolymer resin used in our tools facilitates this resonant quality, unlike the more commonly used ABS plastic or metal, which due to their material density and design have minimal resonating capabilities. However, this resonating ability is not just a byproduct of material choice but a deliberate design feature. For the therapist, this amplification means that vibrations caused by the tool encountering irregularities in the tissue—such as scar tissue, adhesions, or areas of tension—are more perceptible, enhancing the ability to identify fibrotic tissues. This heightened sensitivity provides a feedback mechanism that is acutely attuned to the nuances of individual patient conditions, allowing the therapist to adjust pressure and technique in real-time, thereby tailoring the treatment to the patient's specific needs with unprecedented precision and simultaneously ensuring patient comfort. This feature augments the therapeutic process of soft tissue mobilization techniques such as Gua Sha, especially when applied to delicate areas like the face and the extremities, enhancing the therapeutic experience and outcomes.

Specifically, when addressing treatments on the face—a region where skin sensitivity and hygiene are paramount—the biocompatible and nonporous nature of our tools ensures safety and efficacy. The nonporous surface prevents the harboring of bacteria and facilitates easy sterilization, crucial for maintaining the highest standards of hygiene.

The durable and rigid nature of our tools ensures consistent performance over time, resisting wear and maintaining their shape and smoothness even with rigorous use. This reliability means therapists can apply consistent pressure and technique for effective soft tissue mobilization across various body areas, from the robust tissues of the extremities to the delicate and nuanced regions of the face.

In some embodiments, the tools may have specific texture enhancements or adjustable pressure settings, depending on the intended use and user preference.

In some embodiments, sensors may be integrated into the tools for feedback on pressure and tissue response.

In some embodiments, the tools may be manufactured of advanced materials that can adapt to body temperature or improve patient comfort.

The devices can be formed utilizing additive manufacturing. In embodiments, additive manufacturing can include 3-dimensional resin printing. Additive manufacturing can include a finishing phase for smoothing, sanding, or otherwise fine-tuning the devices, as well as for sterilization.

To use these tools, a practitioner applies the instrument to the patient's affected soft tissue areas. By maneuvering the instrument's uniquely designed edges and surfaces along these areas, they can diagnose and treat soft tissue abnormalities. The instrument's design allows for deep, targeted pressure application, effectively mobilizing the soft tissue. This process helps in breaking down fibrotic tissues, improving circulation, and alleviating pain. It's particularly useful for addressing issues in both larger muscle groups and more delicate areas, enhancing therapeutic outcomes in soft tissue treatment.

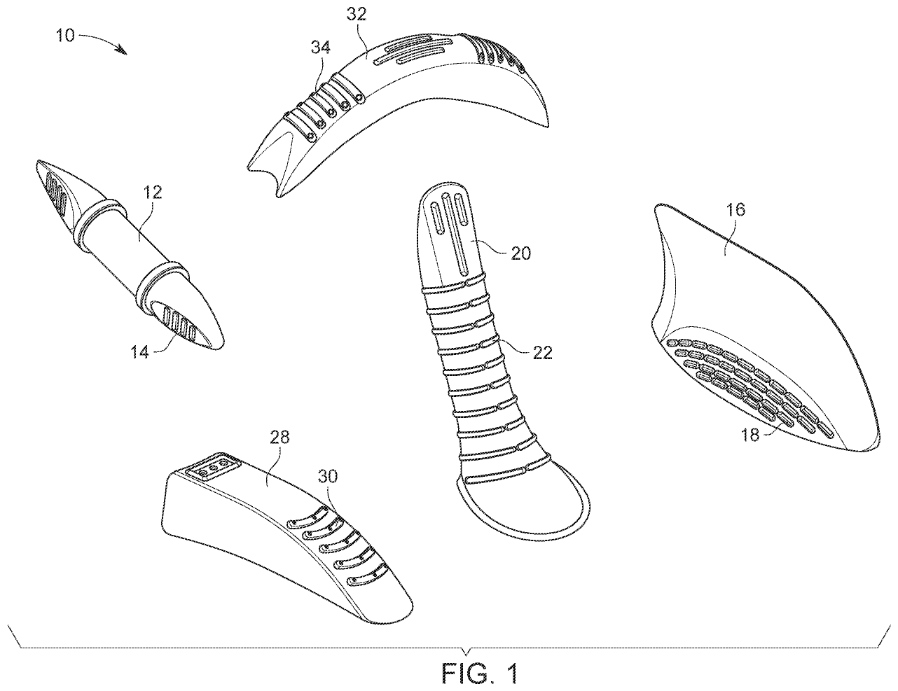

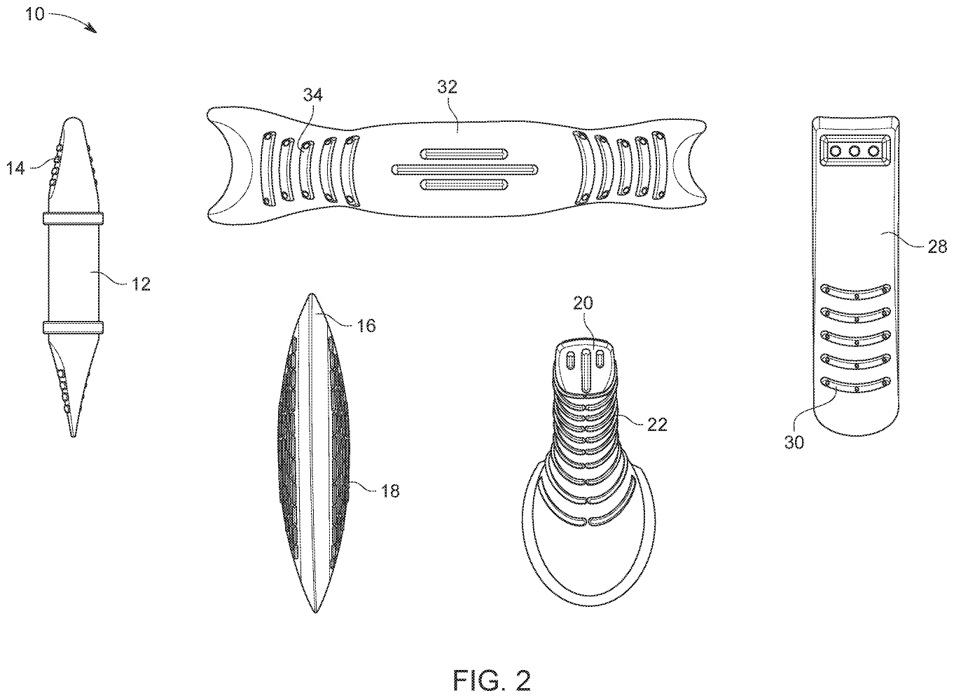

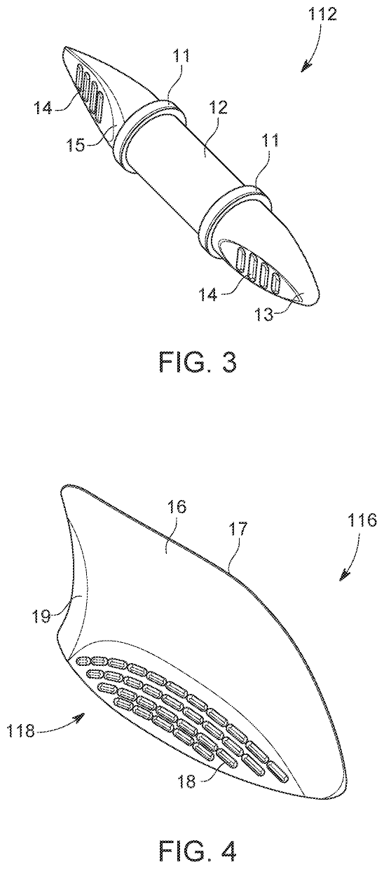

Referring to FIGS. 1-7, FIGS. 1-2 illustrate a set of soft tissue manipulation devices for use in treating soft tissue pathologies. A plurality of soft tissue manipulation devices is illustrated, including a “wedge” tool, a “spoon” tool, a “fin” tool, a “cylinder” tool, and an “arc” tool. The tools are shown individually in FIGS. 3-7.

Referring now to FIG. 3, a first soft tissue manipulation device 112 is illustrated, referred to herein as the “cylinder”. The “cylinder” device 112 may be monolithically formed, including a substantially cylindrical body portion 12 with a radius and a height (i.e., longitudinal length). At each end of the cylindrical body 12, the “cylinder” device 112 is shown with a first interface portion 11 and a second interface portion 11, also referred to herein as “flanges”, substantially cylindrical in shape, each having a radius and a height. In embodiments, the radius of the first interface portion 11 is equal to the radius of the second interface portion 11 and larger than the radius of the body portion 12, while the height of the first interface portion 11 is equal to the height of the second interface portion 11 and smaller than the height of the body portion 12. A substantially cone-shaped portion 13 is joined to the first interface 11 and a rounded, substantially wedge-shaped portion 15 is joined to the second interface 11. The substantially cone-shaped portion 13 tapers to a blunt point and is shown with substantially flat surfaces disposed opposite from one another. Each of the substantially flat surfaces may have a plurality of raised ridges 14 thereon. The substantially wedge-shaped portion 15 is also shown with substantially flat surfaces disposed opposite from one another, meeting at an apex to form a blunt edge. Each of the substantially flat surfaces may have a plurality of raised ridges 14.

Referring to FIG. 4, a “fin” soft tissue manipulation device 116 is illustrated. The “fin” device 116 can include a substantially oval-shaped base 118 with two continuously formed fin-shaped surfaces 16 rising therefrom. The first and second fin-shaped surfaces 16 may meet to form an edge 17 along a portion of a perimeter of the device 116, including a first end. A pair of adjoined surfaces 19 form a curved edge opposite the first end. The adjoined surfaces 19 each adjoins the base 118 and one of the first and second fin-shaped surfaces 16. Each fin-shaped surface 16 of device 116 generally has a plurality of raised ridges 18 disposed thereon. In embodiments, the first and second fin-shaped surfaces 16 may each have a curved protrusion adjacent the base 118. In embodiments, the ridges 18 may be disposed on the curved protrusions, proximate to the base portion of device 116. The ridges 18 may be formed in parallel rows.

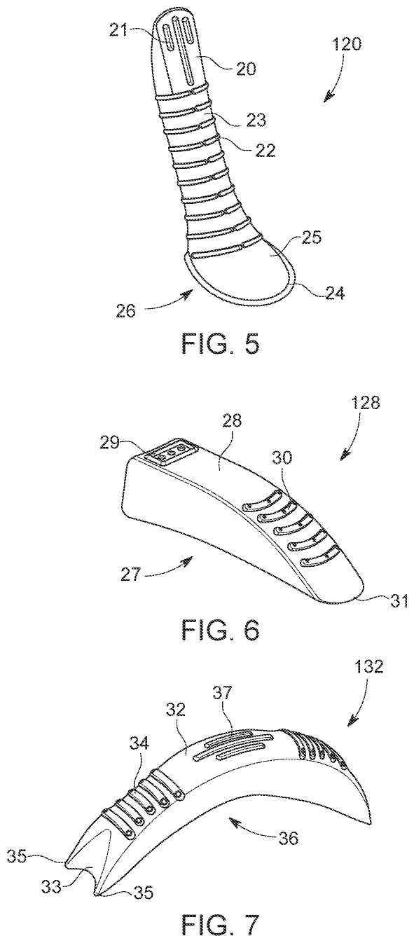

Referring to FIG. 5, a third soft tissue manipulation device 120 is illustrated. Device 120 can be monolithically formed and may include a substantially semi-cylindrically shaped body 23 with a base portion 25 at a first end and a tip portion 20 at a second end. The base portion 25 of device 120 can have a substantially u-shaped footprint bordered by flange 24 surrounding a concave surface 26. The tip portion 20 may have a substantially flat surface rising to a curved edge and can have a plurality of ridges 21 formed thereon. The body portion of device 120 can also have a plurality of ridges 22. The ridges 21 shown on the tip portion 20 are shown oriented perpendicularly to the ridges 22 on the body 23.

Referring to FIG. 6, a fourth soft tissue manipulation device 128 is illustrated. Device 128 can include a substantially curved wedge-shaped body, defined by a plurality of surfaces. In embodiments, the body of device 128 can include at least five surfaces which can include: a first substantially rectangularly-shaped surface defined as a rear surface; a second substantially rectangularly-shaped surface 27 defined as a bottom surface; at least two side surfaces comprising two arced edges converging at a front end 31 and joined by a rear edge; and an arced, substantially rectangularly-shaped surface, defined as a top surface 28.

The top surface 28 of device 128 can include a plurality of arced ridges 30 disposed on at least a portion thereof. A rectangular ridge 29 may be formed on the top surface 28 adjacent to the rear end.

Referring to FIG. 7, a fifth soft tissue manipulation device 132 is illustrated. Device 132 may have a substantially crescent-shaped body portion with a convex upper surface 32 converging with a concave lower surface 36 to form a first end portion and a second end portion. The first end portion and the second end portion of device 132 may each have a semiconical recess 33, forming a pair of adjacent prongs 35. Device 132 as illustrated has a plurality of ridges 34, 37 disposed on the upper surface 32, with ridges 34 disposed on the body proximate to the first end and the second end of the device 132, and another set of ridges 37 disposed therebetween, oriented perpendicularly to both the first and the second set of ridges 34.

It should be understood, of course, that the foregoing relates to exemplary embodiments of the invention and that modifications may be made without departing from the spirit and scope of the invention as set forth in the following claims.

What is claimed is:

1. A set of ergonomic soft tissue manipulation tools for applying pressure to skin of a patient's body, wherein each of the ergonomic soft tissue manipulation tools comprises:
an elongated monolithic body, having a first tapered end configured in an arc corresponding to a contour of a selected part of the patient's body, with a plurality of ridges formed on the elongated monolithic body;
wherein the first tapered end is operative to diagnose and treat soft tissue abnormalities.

2. The set of claim 1, wherein the elongated monolithic body has a substantially wedge shape with a substantially rectangular cross section, comprising a concave surface and a convex surface converging to form the first tapered end, with a sidewall joining a second end of the concave surface and the convex surface, and a rectangular ridge formed on the convex surface proximal to the second end thereof, and wherein the plurality of ridges are disposed laterally in parallel along the convex surface proximal to the first tapered end.

3. The set of claim 1, wherein the elongated monolithic body has a central shaft with the first tapered end and a concave surface having a flange its periphery at a second end opposite the first tapered end, wherein the plurality of ridges include a first group of parallel lateral ridges formed along the central shaft of the elongate monolithic body and a second group of parallel longitudinal ridges proximal to the first tapered end.

4. The set of claim 1, wherein the elongated monolithic body has a substantially triangular cross-section, wherein two of three sides of the substantially triangular cross-section have a curvilinear protrusion abutting a third of the three sides of the substantially triangular cross-section and the plurality of ridges are formed longitudinally on each curvilinear protrusion, and further comprising a convex edge at a second tapered end opposite the first tapered end.

5. The set of claim 1, wherein the first tapered end forms a semi-cylindrical recess between prongs, further comprising a second tapered end mirroring a configuration of the first tapered end, wherein the elongated monolithic body has a central arcuate shaft, and wherein the plurality of ridges comprise longitudinal ridges formed on a convex surface of the central arcuate shaft.

6. The set of claim 5, further comprising lateral ridges formed proximal to the first tapered end and the second tapered end.

7. The set of claim 1, wherein the elongated monolithic body has a central cylindrical shaft with a second tapered end opposite the first tapered end, wherein a flange is formed between the central cylindrical shaft and each of the first tapered end and the second tapered end, respectively, and wherein the plurality of ridges is formed laterally along converging surfaces forming the first tapered end and the second tapered end.

8. The set of claim 7, wherein the first tapered end forms a blunt point and the second tapered end forms a blunt edge.

9. The set of claim 1, wherein the ergonomic soft tissue manipulation tools are formed of a thermoset polymer.

10. A method of making the set of claim 1, comprising:
printing, utilizing stereolithography, the ergonomic soft tissue manipulation tools from a thermoset resin; and
smoothing the ergonomic soft tissue manipulation tools.
